(19) United States
(12) Patent Application Publication
(10) Pub. No.: US 2003/0140757 A1
(43) Pub. Date: Jul. 31, 2003

(54) Storage compartment for a paper trimmer

(75) Inventors: Christopher R. Carlson, Wausau, WI (US); William J. Schulz, Mosinee, WI (US)

Correspondence Address: FOLEY & LARDNER, 330 NORTH WABASH AVENUE, SUITE 3300, CHICAGO, IL, 60611-3608, US

(73) Assignee: Alterra Holdings Corporation

(21) Appl. No.: 10/056,582

(22) Filed: Jan. 25, 2002

(51) Int. Cl. B26B 1/00; B25F 3/00; B26B 3/00; B26B 11/00; B26D 7/02; B26D 1/18; B23D 19/00; B26D 5/08

(52) U.S. Cl. 83/485; 30/125; 83/455; 83/564; 83/588; 83/614

(57) ABSTRACT

A removable storage compartment assembly for a material cutter comprising a compartment placement region and a removable storage compartment. The storage compartment includes a compartment lower portion removably engaged to the compartment placement region and a compartment upper portion removably and mateably engaged to the compartment lower portion. A biasing member is operatively connected to the compartment lower portion. When the compartment lower portion is disengaged from the compartment placement region, the biasing member biases the compartment lower portion away from the compartment placement region.

### FIELD OF THE INVENTION

The present invention is directed to a material cutter. More particularly, the present invention is related to a material cutter that is relatively simple to use and incorporates an easily replaceable cutting edge.

### BACKGROUND OF THE INVENTION

A number of cutting boards with material cutting devices attached thereto are conventionally known. One type of “paper trimmer” comprises a cutting board with a rail assembly coupled thereto. A carriage assembly is mounted on the rail assembly for translational movement across the cutting board, thereby cutting or trimming various materials. A circular blade is mounted in the carriage assembly for rotary motion.

Although such cutting assemblies are conventionally known, conventional paper trimmers include a number of limitations. For example, the cutting blade on the paper trimmer often becomes worn, bent or irregularly configured over time, resulting in a non-uniform cut of the paper or other material. For this reason, it is necessary to provide a number of replacement blades for the paper trimmer. A number of replacement blades may be sold with the original paper trimmer for this purpose. Over time, however, the user may run out of replacement blades, requiring that he or she purchase separately new replacement blades from the paper trimmer.

Furthermore, the cutting blades for the paper trimmer often include a very sharp edge in order to provide for a clean cut. Therefore, it is desirable that the replacement blades be packaged in a manner such that the likelihood of accidental injury is minimized. Furthermore, many currently existing paper trimmers include no storage mechanism for storing the replacement blades. While some paper trimmers do include a storage area, the storage area is often exposed to the outside environment, resulting in the blade edge also being exposed and potentially injuring the user and/or damaging the blade. It would therefore be desirable to provide a storage assembly for blades which minimizes the exposure of the cutting blades to the user and the environment, while also being easily incorporated into the paper trimmer.

### SUMMARY OF THE INVENTION

It is therefore an object of the invention to provide a removable storage compartment for a material cutter.

It is another object of the invention to provide a replaceable blade storage compartment for a material cutter.

It is still another object of the invention to provide a storage compartment for cutting blades that is relatively simple to manufacture.

It is finally another object of the present invention to provide an improved storage compartment for cutting blades which is relatively simple to replace.

In accordance with the above objects, a blade storage compartment comprises a base, a compartment lower portion removably engaged to the base, a compartment upper portion removably and mateably engaged to the compartment lower portion, and a biasing member operatively connected to the compartment lower portion. When the compartment lower portion is disengaged from the base, the biasing member biases the compartment lower portion away from the base.

### BRIEF DESCRIPTION OF THE DRAWINGS

The foregoing advantages and features of the invention will become apparent upon reference to the following detailed description and the accompanying drawings, of which:

FIG. 1 is an exploded perspective view of a storage compartment assembly in accordance with the present invention;

FIG. 2 is a sectional perspective view of the storage compartment assembly of FIG. 1;

FIG. 3 is a perspective view of the combination compartment upper portion and compartment lower portion of FIG. 1;

FIG. 4 is a top view of the compartment placement region;

FIG. 5 is a perspective view of a cutting board showing a carriage assembly mounted on the rail assembly and the storage compartment assembly of FIG. 1;

FIG. 6 is a front elevation view of the cutting board of FIG. 5, showing the carriage assembly mounted on the rail assembly;

FIG. 7 is an exploded perspective view of one end of the rail assembly;

FIG. 8 is a cross section view taken on line 8-8 of FIG. 6;

FIG. 9 is an exploded perspective view of the carriage assembly;

FIG. 10 is a perspective view of the trolley;

FIG. 11 is a perspective view of the back of the cover;

FIG. 12 is a cross section view of the carriage assembly taken on line 12-12 of FIG. 6 of the front of the trolley;

FIG. 13 is a cross section view similar to FIG. 12 showing a pinking blade in the carriage assembly;

FIG. 14 is a view similar to FIG. 11 shown in the cutting position;

FIG. 15 is a top view of the paper cutter mounted on a craft cutter board; and

FIG. 16 is an elevation view of the craft cutter board.

### DETAILED DESCRIPTION OF THE INVENTION

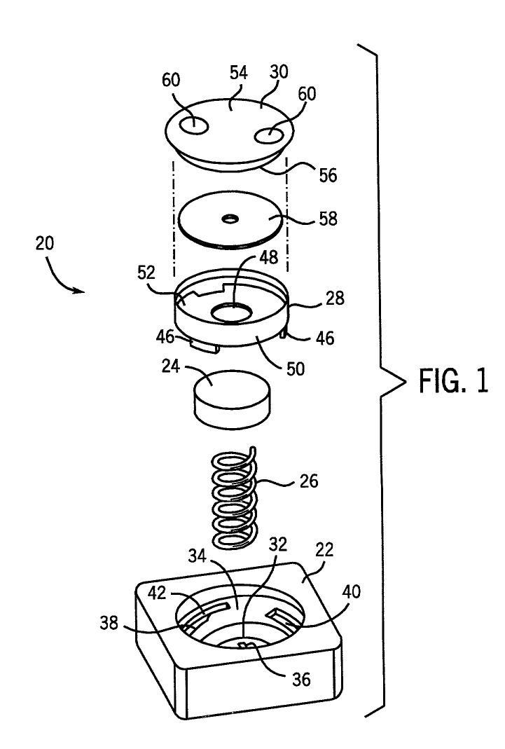

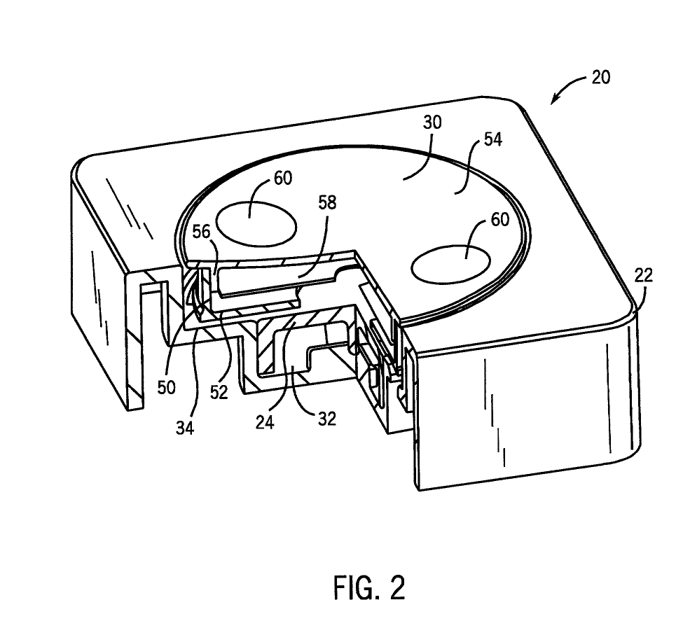

A storage compartment assembly constructed in accordance with the present invention is shown generally at 20 in FIGS. 1 and 2. The storage compartment assembly 20 includes a compartment placement region 22, an abutment member 24, a biasing member 26, a compartment lower portion 28 and a compartment upper portion 30.

The compartment placement region 22, as shown in FIGS. 1, 2 and 4, includes a central depression 32 and an elevated portion 34. The central depression 32 is sized to accept the abutment member 24 while also including a stud 36 upon which the biasing member 26 may be placed. Above and substantially around the central depression 32 is the elevated portion 34 which is sized to accept the compartment lower portion 28. The elevated portion 34 also includes a plurality of locking grooves 38. Each of the locking grooves 38 includes a large groove portion 40 and a small groove portion 42 (best shown in FIG. 4). In a preferred embodiment of the invention, there are three locking grooves 38 along the outer edge of the elevated portion 34, with the large groove portion 40 being substantially the same length as the small groove portion 42. The locking grooves 38 are used to secure and unsecure the compartment lower portion 28 from the compartment placement region 22 as will be described hereinafter.

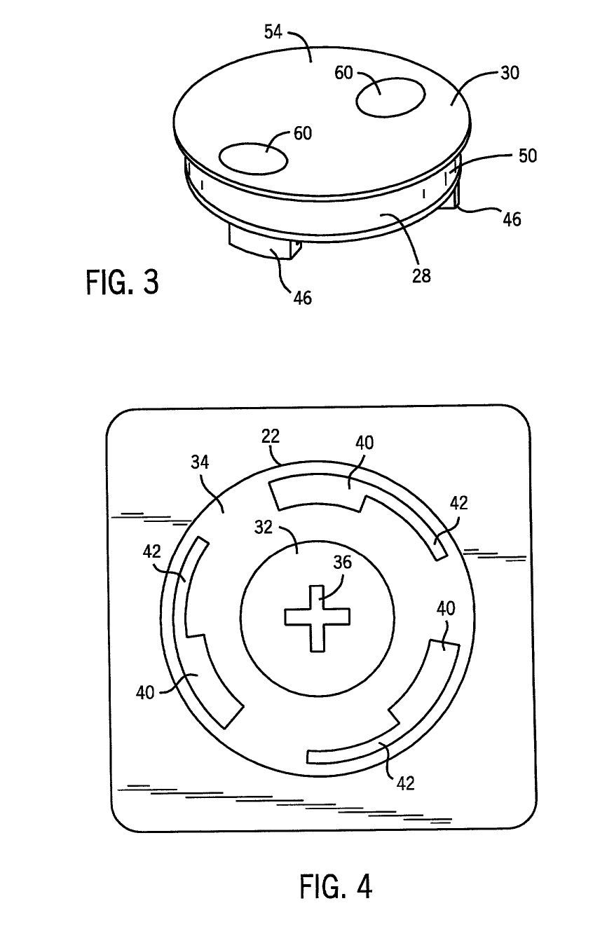

The compartment lower portion 28 and the compartment upper portion 30 are removably attached to each other, enclosing a region in which one or more cutting blades 58 may be placed. As shown in FIGS. 1 and 3, the compartment lower portion 28 comprises a lower portion bottom 52 that is bounded by a lower portion side wall 50. In one embodiment of the invention, a central opening 48 is located in the center of the lower portion bottom 52. The lower portion bottom 52 of the compartment lower portion 28 also includes a plurality of hook members 46 located along the outer edge of the lower portion bottom 52. The hook members 46 are positioned to substantially correspond to the locking grooves 38 within the compartment placement region 22. The compartment upper portion 30 includes an upper portion top 54 that is bounded by an upper portion side wall 56. In one preferred embodiment of the invention, the compartment upper portion 30 also includes a plurality of finger tabs 60 in the form of depressions. The plurality of finger tabs 60 may be used by the user to rotate the compartment upper portion 30.

The compartment lower portion 28 and the compartment upper portion 30 are sized to mate with each other. In a preferred embodiment of the invention, the upper portion side wall 56 fits within the region defined by the lower portion side wall 50. The compartment lower portion 28 and the compartment upper portion 30 combine to provide a region in which a plurality of cutting blades 58 may be placed. In a preferred embodiment of the invention, several of the cutting blades 58 may be placed between the compartment lower portion 28 and the compartment upper portion 30. Additionally, the user may place his/her finger within the central opening 48, pushing up the individual cutting blades 58, providing an easier method of removing the cutting blades 58 from the compartment lower portion 28 with a reduced risk of injury.

The abutment member 24 is positioned to fit between the compartment placement region 22 and the compartment lower portion 28, while also being sized slightly larger than the central opening 48. In one particular embodiment of the invention, the under side of the abutment member 24 includes an abutment member stud (not shown) for receiving one end of the biasing member 26. Preferably the biasing member 26 comprises a standard coil spring, although other types of biasing members may also be used. The biasing member 26, being bounded by the abutment member stud and the compartment placement region stud 36, is snugly positioned between the abutment member 24 and the compartment placement region 22.

The operation of the storage compartment assembly 20 is generally as follows. As discussed above, the compartment lower portion 28 and the compartment upper portion 30 removably engage each other to house a plurality of cutting blades 58. Both the compartment lower portion 28 and the compartment upper portion 30 are completely removable from the compartment placement region 22, permitting that portion of the storage compartment assembly 20 to be sold as a separate unit with a plurality of the cutting blades 58.

The abutment member 24 and the biasing member 26 remain secured to the compartment placement region 22. When a user desires to fasten the compartment upper portion 30 and the compartment lower portion 28 to the remainder of the storage compartment assembly 20, the user places the compartment lower portion 28 into the storage compartment assembly 20 such that the hook members 46 substantially align with the large groove portion 40 of each of the locking grooves 38. By depressing the compartment upper portion 30, both the compartment upper portion 30 and the compartment lower portion 28 act against the abatement member 24 and the biasing member 26, moving the hook members 46 into the large groove portions 40. Once the hook members 46 are within the large groove portions 40, the user rotates the compartment upper portion 30, along with the compartment lower portion 28, in a clockwise direction. This rotation moves the hook members 46 into engagement with the small groove portions 42, effectively locking the compartment lower portion 28 to the compartment placement region 22.

In the event that the user desires to remove one of the cutting blades 58 from the storage compartment assembly 20, the user simply rotates the compartment upper member 30 and the compartment lower member 28 in a counterclockwise direction, disengaging the compartment lower portion 28 from the compartment placement region 22. The user is then free to remove the compartment upper portion 30 from the compartment lower portion 28 and remove one or more cutting blades 58.

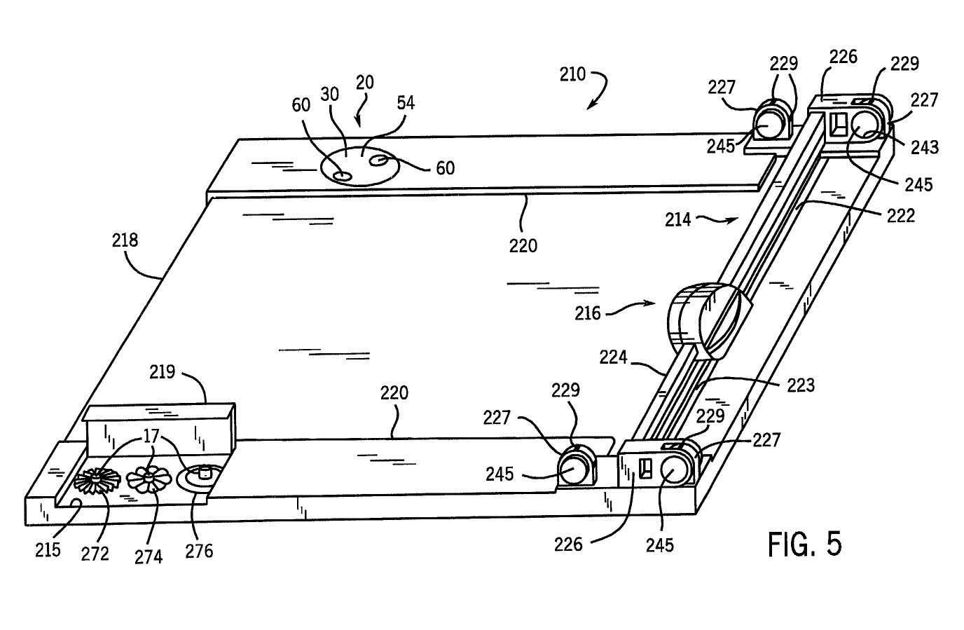

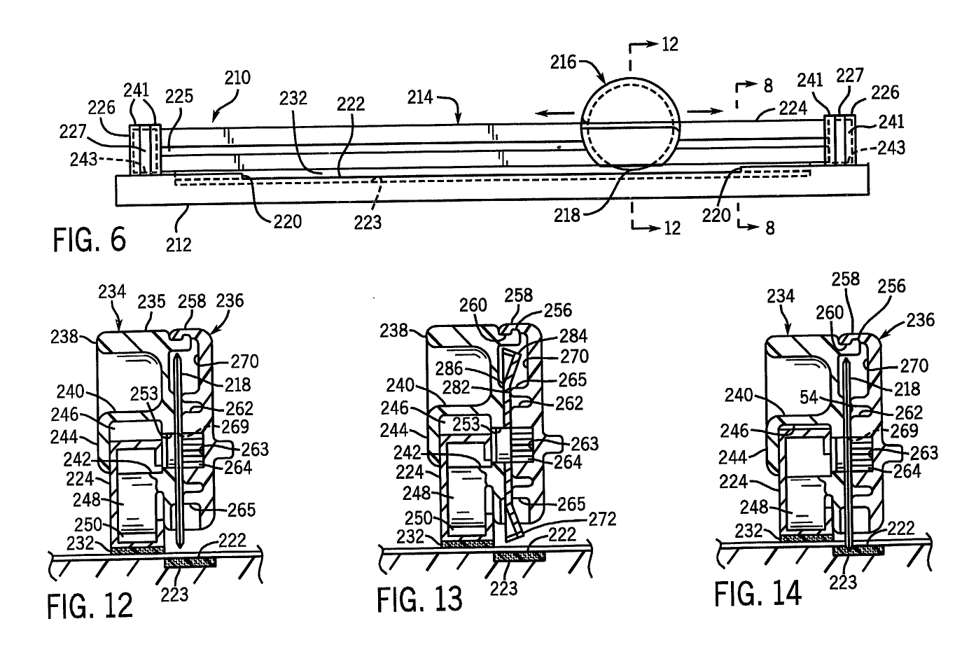

The storage compartment assembly 20 of the present invention could be used with a variety of office tools, including material cutters and material trimmers of different sizes and functions. For example, one paper cutter with a circular blade which could include a storage compartment in accordance with the present invention is disclosed in U.S. Pat. No. 5,322,001, issued to Boda on Jun. 21, 1994 and incorporated herein by reference. A paper cutter 210 as shown in FIGS. 5 and 6 generally includes a cutting board 212, a rail assembly 214 pivotally mounted on one end of the cutting board and a carriage assembly 216 mounted on the rail assembly 214 for movement across the cutting board. The carriage assembly 216 includes a circular cutting blade 218 for cutting or trimming various materials aligned with the rail assembly 216. Although a flat circular cutting blade is described herein, circular pinking, perforating or wave blades can be used to provide different shaped edges on the paper or material sheets.

The cutting board 212 includes a paper guide 20 on each side of the cutting board 212 for aligning paper stock under the carriage assembly 216. A self-healing pad 222 may be mounted in a groove 223 in the cutting board 212 beneath the carriage assembly 216. An additional recess 215 may be provided in the cutting board 212 for providing additional storage space for the various cutting blades on pins 217. A cover 219 is pivotally mounted on the board to enclose the additional recess 215.

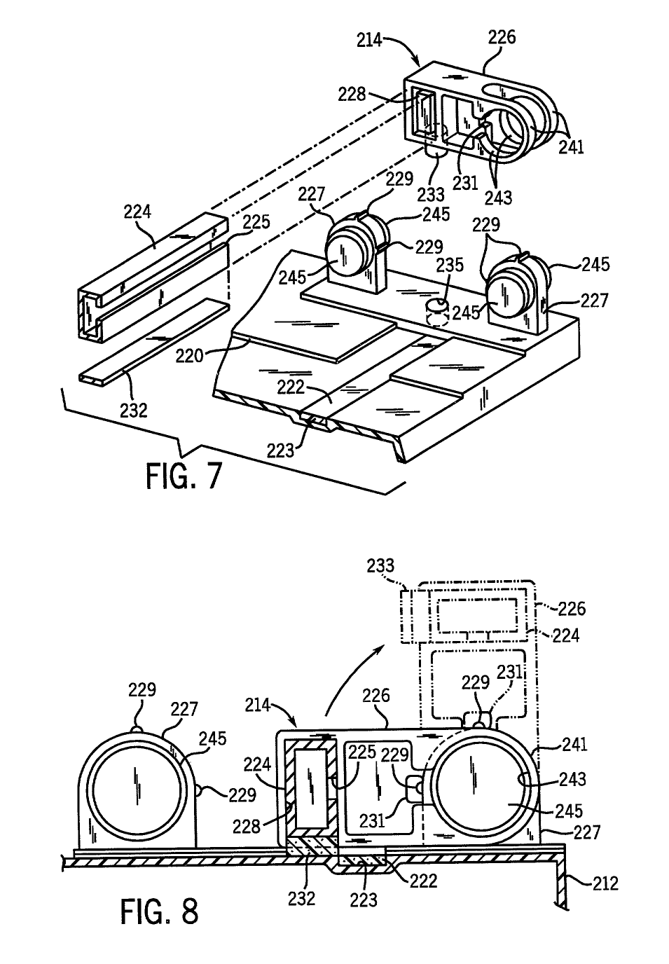

The rail assembly 214 as shown in FIGS. 7 and 8 includes a rectangular rail 224 having an opening 225 on one side. The rail is supported at each end by pivot posts 226 which are pivotally mounted on pivot blocks 227. The ends of the rail 224 are seated in rectangular grooves 228 at the upper end of each of the pivot posts 226. A foam pad 232 is mounted on the bottom of the rail 224 to engage and hold the paper or other material in position on the cutting board 212 when moved to the cutting position. A guide 233 is provided on the side of each of the pivot posts 226 which is aligned with a recess 235 in the cutting board to stabilize the rail assembly above the paper.

The pivot posts 226 are pivotally mounted on the pivot blocks 227 mounted on each side of the cutting board 212. In this regard, each of the posts 226 has a pair of legs 241. Each of the legs 241 includes openings 243 which matingly engage protrusions 245 provided on each side of the pivot blocks 227. A limit stop 229 is provided on the top and side of each of the pivot blocks 227 to engage a latch 231 in the pivot post 226 to hold the rail assembly in the open or operative position.

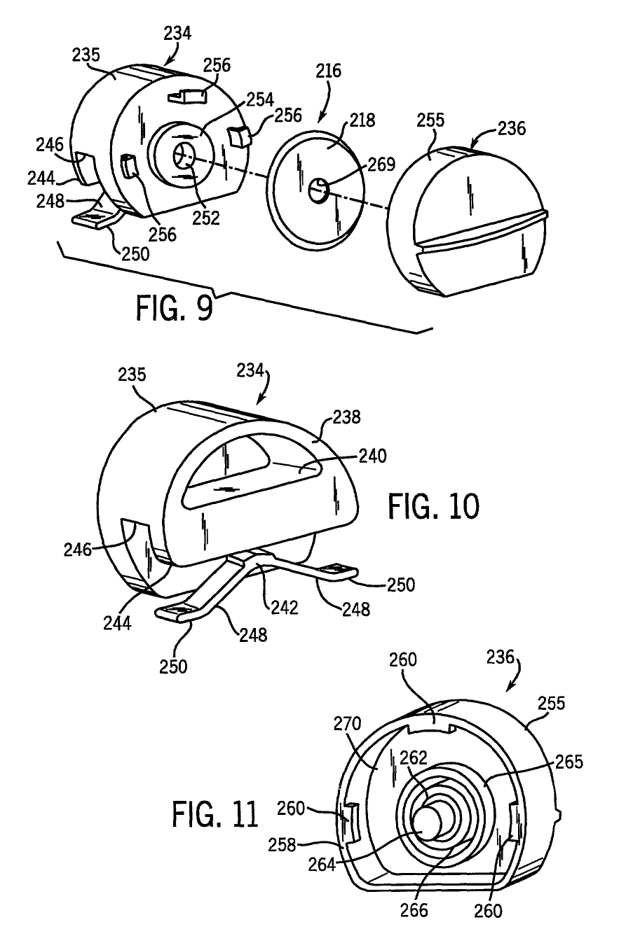

The carriage assembly 216 as shown in FIGS. 9-12 includes a trolley 234 and a cover 236. The trolley 234 is in the form of a molded plastic piece having a semi-circular body 235. A flange 238 is provided around the upper edge of the body 235 which terminates at a ledge 240. A flange 244 depends from the ledge 240 downward to form a space 246 to accommodate the upper portion of the rail 224. A pair of leaf springs 248 are molded on a support member 242 below the flange 244 which extend outwardly and downwardly therefrom. The ends 250 of the springs 248 are in the form of pads which slide across the inside of the rail 224 as described hereinafter. The front side of the body 235 includes a hole 252 centrally located on the face of the body 235 and surrounded by a circular support surface 254. A set of three L-shaped flanges 256 are molded on the perimeter of the front of the body 235.

The cover 236 is in the form of a semi-circular housing 255 having a flange 258 around the outer perimeter. A number of tabs 260 corresponding to the number of flanges 256 on the trolley are located around the edge of the flange 258. A hub 262 having a blind bore 263 is provided in the center of the housing 255. A steel pin 264 is positioned in the bore 263. A circular ridge 265 is formed around the hub 262 which forms a recess 270 between the ridge 265 and the ridge 258. On assembly the cover 236 is rotated far enough for the tabs 260 to clear the flanges 256. The pin 264 is aligned with the hole 252 in the trolley 234 and the cover rotated to interlock the tabs 260 with the flanges 256.

The rotary cutting blade 218 includes a center opening 269 and is mounted on the pin 264 in abutting engagement with support surface 254 when the cover 236 is mounted on the trolley 234. It should be noted that the recess 270 provided around the periphery of the ridge 265 accommodates the cutting blades 218 having cutting edges offset from the center of the blade. In this regard a pinking blade 272 or other types of blades can be stored on the pins 217 in recess 215. A pinking blade 272 is shown in FIG. 13 mounted on pin 264. The pinking blade 272 has a center section 282 and a cutting edge 284 offset from the center section 286 into the space 270 provided in cover 236.

The trolley 234 is mounted on the rail 224 by sliding the leaf springs 248 into the inside of the rail with the flange 244 aligned with the outside of the rail 224. One of the cutting blades is mounted on pin 264 and the cover 236 mounted on the trolley 234. In operation the paper sheets are aligned with one edge of the groove 223 and moved under the rail assembly 214. The rail assembly 214 is pivoted to the operative position with the foam pad 232 resting on the edge of the paper. The carriage assembly is pushed down as shown in FIG. 14 far enough for the blade 218 to engage the self-healing mat 222. The carriage assembly is then pushed across the rail assembly. The blade will roll across the mat cutting or trimming the edge of the paper sheet. When released the springs 248 will bias the carriage assembly upward to clear the blade from the paper.

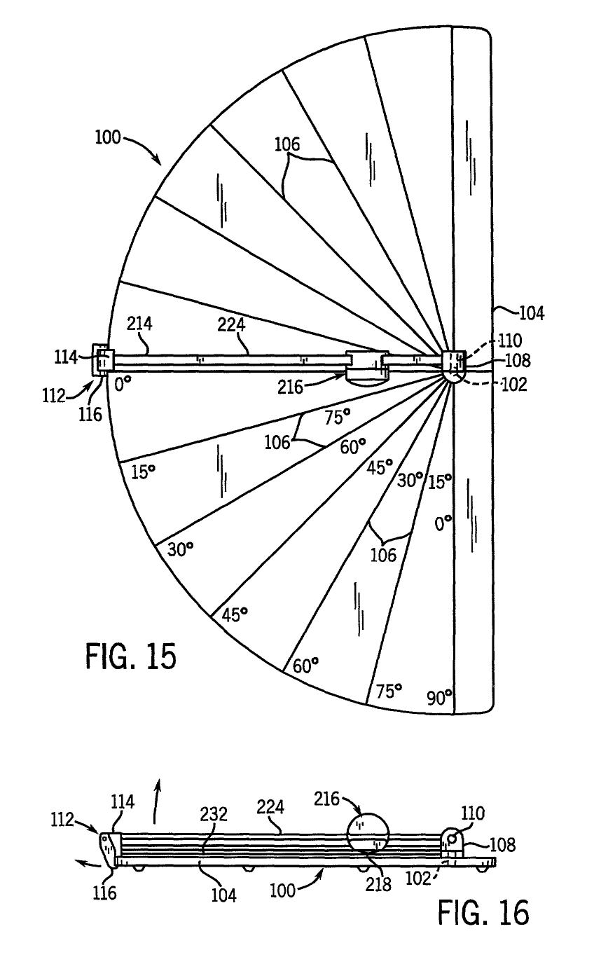

The paper cutter as described herein can also be used in combination with a craft cutter board 100 as shown in FIGS. 15 and 16. The craft board is in the form of a semi-circle having a pivot point 102 at the mid point of the straight edge 104. Radial lines 106 are drawn outwardly from the pivot point 102 at fifteen degree intervals. The rail assembly 214 has been modified by removing the pivot posts 226 and mounting a center post 108 on one end of the rail 224 and a clamp assembly 112 at the other end of the rail 224. The center post 108 is free to pivot about pivot point 102 and the rail 224 is free to pivot about pivot pin 110 at the top of center post 108. The clamp assembly 112 includes an end cap 114 mounted on the rail 224 and an over center latch 116 which is free to pivot about end cap 114 into engagement with the edge of board 100. Paper aligned with the 0 degree radial line 106 will be secured to the board 100 by the pad 232 when the rail assembly 214 is latched to the board 100. The carriage assembly can then be pushed down and moved across the rail assembly 214 to cut the paper.

It should be understood that the above description of the invention and specific examples and embodiments, while indicating the preferred embodiments of the present invention are given by demonstration and not limitation. For example, the shapes and sizes of the storage system components may vary, along with the types of biasing mechanisms and latching mechanisms. Many changes and modifications within the scope of the present invention may therefore be made without departing from the spirit thereof and the present invention includes all such changes and modifications.

What is claimed is:

1. A blade storage compartment, comprising:
a base,
a compartment lower portion removably engaged to the base;
a compartment upper portion removably and mateably engaged to the compartment lower portion; and
a biasing member operatively connected to the compartment lower portion,
wherein when the compartment lower portion is disengaged from the base, the biasing member biases the compartment lower portion away from the base.

2. The blade storage compartment of claim 1, wherein the biasing member comprises a coil spring.

3. The blade storage compartment of claim 2, further comprising an abutment member positioned between the biasing member and the compartment lower portion.

4. The blade storage compartment of claim 3, wherein the compartment lower portion includes an opening substantially opposite the compartment upper portion, and wherein the abutment member contacts a region of the compartment lower portion substantially adjacent the opening.

5. The blade storage compartment of claim 2, wherein the base includes a plurality of grooves, and wherein the compartment lower member includes a plurality of hooks removably engaging the plurality of grooves, the engagement of the plurality of hooks and the plurality of grooves coupling the compartment lower portion to the base.

6. The blade storage compartment of claim 5, wherein the plurality of grooves and the plurality of hooks are positioned in a substantially radially symmetrical arrangement about an axis defined by the biasing member.

7. The blade storage compartment of claim 6, wherein the compartment lower portion rotatably engages and disengages the base.

8. A storage compartment assembly for a material cutter, comprising:
a compartment placement region,
a removable storage compartment including:
a compartment lower portion removably engaged to the compartment placement region, and
a compartment upper portion removably and mateably engaged to the compartment lower portion; and
a spring operatively connected to the compartment lower portion,
wherein when the compartment lower portion is disengaged from the compartment placement region, the spring biases the compartment lower portion away from the compartment placement region.

9. The storage compartment assembly of claim 8, wherein the compartment placement is formed as part of a material cutter.

10. The storage compartment assembly of claim 9, further comprising an abutment member positioned between the spring and the compartment lower portion.

11. The storage compartment assembly of claim 10, wherein the compartment lower portion includes an opening substantially opposite the compartment upper portion, and wherein the abutment member contacts a region of the compartment lower portion substantially around the opening.

12. The storage compartment assembly of claim 11, wherein the storage compartment is sized to store a plurality of blades for the material cutter, the blades being larger than the opening.

13. The storage compartment assembly of claim 12, wherein the spring comprises a coil spring.

14. The storage compartment assembly of claim 8, wherein the compartment lower portion rotatably engages and disengages the compartment placement region.

15. The storage compartment assembly of claim 8, wherein the compartment placement region includes a plurality of grooves, and wherein the compartment lower member includes a plurality of hooks corresponding to and removably engaging the plurality of grooves, the rotatable engagement of the plurality of hooks and the plurality of grooves coupling the compartment lower portion to the compartment placement region.

16. A material cutter comprising:
a base;
a cutting assembly including:
a cutting board,
a pair of posts mounted on the cutting board;
a rail assembly pivotally mounted on the posts in a substantially parallel relation to the cutting board, and
a carriage assembly mounted on and movable along the rail assembly, the carriage assembly having a cutting blade for cutting a material; and
a storage compartment including:
a compartment placement region formed within the base,
a compartment lower portion removably engaged to the compartment placement region;
a compartment upper portion removably and mateably engaged to the compartment lower portion; and
a biasing member operatively connected to the compartment lower portion,
wherein when the compartment lower portion is disengaged from the compartment placement region, the biasing member biases the compartment lower portion away from the compartment placement region.

17. The material cutter of claim 16, wherein the biasing member comprises a coil spring.

18. The storage compartment of claim 17, further comprising an abutment member positioned between the spring and the compartment lower portion, wherein the compartment lower portion includes an opening substantially opposite the compartment upper portion, and wherein the abutment member contacts a region of the compartment lower portion substantially around the opening.

19. The storage compartment of claim 18, wherein the storage compartment is sized to store a plurality of blades for the material cutter, the blades being larger than the opening.

20. The storage compartment of claim 16, wherein the compartment lower portion rotatably engages and disengages the compartment placement region.
